(19) United States
(12) Patent Application Publication
(10) Pub. No.: US 2011/0068283 A1
(43) Pub. Date: Mar. 24, 2011

(54) ELECTROMAGNETIC WAVE ABSORPTION COMPONENT AND DEVICE

(75) Inventors: Shey-Shi Lu, Taipei (TW); Ying-Jay Yang, Taipei (TW); Shuo-Hung Chang, Taipei (TW); Jian-Yu Hsieh, Taipei (TW); Kuan-Ting Lin, Taipei (TW); Tao Wang, Taipei (TW); Chih-Chung Su, Taipei (TW); Cheng-Hung Li, Taipei (TW); Neng-Kai Chang, Taipei (TW)

(73) Assignee: NATIONAL TAIWAN UNIVERSITY, Taipei (TW)

(21) Appl. No.: 12/695,557

(22) Filed: Jan. 28, 2010

(30) Foreign Application Priority Data
Sep. 23, 2009 (TW) 98132038

(51) Int. Cl. G21F 1/10

(52) U.S. Cl. 250/515.1

(57) ABSTRACT

The invention provides electromagnetic wave absorption components and device. The electromagnetic wave absorption component includes an electromagnetic shield constituted by at least one material selected from the group consisting of a carbon nanocoil and a carbon fiber, and a solidified layer formed of a mixture of a solidifiable material and the electromagnetic shield after solidification. Another embodiment of the electromagnetic wave absorption component includes an electromagnetic shield constituted by at least one material selected from the group consisting of a carbon nanocoil and a carbon fiber, and a solidified layer, formed by solidifying a solidifiable material, applicable to encapsulating the electromagnetic shield. Further, the electromagnetic wave absorption device is formed by stacking at least two of the above-mentioned electromagnetic wave absorption components.

### BACKGROUND OF THE INVENTION

1. Field of the Invention

The present invention relates to electromagnetic wave absorption components and devices, and particularly to electromagnetic wave absorption components and device that utilize a carbon nanocoil or carbon fiber as an electromagnetic wave absorption material.

2. Description of Related Art

An electronic device or apparatus derived by electric power generates electromagnetic waves during operation. Along with the consumer's increasing demands on efficiency of the electronic devices such as integrated circuits or mobile phones, operating frequency and signal frequency of the electronic devices such as clock frequency of microprocessors and carrier frequency in mobile communication systems have reached a level of gigahertz (GHz). However, neither the impedance at the input end nor the impedance at the output end of the electronic devices, such as microprocessors, can perfectly match, and thus generate the electromagnetic waves. The electromagnetic waves not only adversely affect the efficiency of the electronic devices but also possibly interfere with the operation of other electronic components. Particularly for precision integrated circuits or microprocessors, internal or external EMI (electromagnetic interference) may cause erroneous calculations and efficiency losses. Meanwhile, since the carrier frequency of mobile phones also reaches the level of GHz, subscribers who closely use mobile phones for a lengthy time are exposed to a high frequency electromagnetic wave environment which may cause deterioration of health.

Therefore, in recent years, there have been constantly developed various techniques for insulating or absorbing electromagnetic waves so as to reduce the adverse effects of the electromagnetic waves on human bodies or insulate electromagnetic waves from the surrounding environment. Currently, a microwave-absorbing foam is commonly used as an electromagnetic wave absorption material. Since it has the characteristics of a lighter weight, high electromagnetic wave absorption efficiency and effective shielding for interferences, it is widely applied in EMI shielding, electromagnetic wave insulation, noise suppression and for military purposes. In addition to preventing electromagnetic waves from interfering with the operation of electronic devices, the microwave-absorbing foam prevents the adverse effects of environmental electromagnetic waves from human bodies. However, the current products of PU microwave-absorbing foam in the market have a sponge-like open-pore structure which is moisture absorbent and thus is not applicable to an outdoor activity.

At present time, the most common method adopted in the industry for absorbing electromagnetic waves or suppressing noises involves adding various kinds of electrically conductive materials such as Cu, Ni, Zn or metallic compounds in the housing of electronic devices or apparatus, or coating a conductive layer through such as copper electroplating or sand blasting on the interior of the housing, or embedding a metal sheet on the inner side of the housing. However, such method increases the fabrication cost and results in an environmental problem.

A more advanced technique for absorbing electromagnetic waves or suppressing noises is achieved in the art by adding an electromagnetic wave absorption material to an insulation substrate. For example, Mn—Zn ferrite or Ni—Zn ferrite can be used as an electromagnetic wave absorption material and added to silicone gel, as disclosed by Japan Patent No. JP-A11-335472. However, such a method is only applicable in a low frequency range. Also, the ferrite material is easy to rust and thus is not suitable for long-term use. Further, Taiwan Patent Publication No. 143069 discloses the use of a BaTiO₃ powder for electromagnetic wave absorption. Nevertheless, since there is a large difference between the weight of BaTiO₃ and the substrate (such as plastic or rubber material), BaTiO₃ cannot be uniformly distributed in the substrate. In this regard, the electromagnetic wave absorption effect is only locally decreased. Since the use of BaTiO₃ requires an increased cost, it is not suitable as a candidate material that is cost-effective and has good electromagnetic wave absorption efficiency.

Therefore, it is desirable to provide electromagnetic wave absorption components that are cost-effective and of easy use in daily life and electronic devices, and meanwhile achieve good effects on suppressing noises or insulating harmful electromagnetic waves. However, the electromagnetic wave absorption and noise suppression techniques in the art cannot achieve the desired effect and cannot be widely applied to the level of daily life or large-scale industries.

Accordingly, there is a practical need to efficiently protect the precise electronic devices in operation from being interfered by external electromagnetic noises, insulate electromagnetic waves scattered out from the electronic devices, and selectively absorb or shield the electromagnetic waves harmful to human bodies.

### SUMMARY OF THE INVENTION

In view of the above drawbacks, the present invention provides an electromagnetic wave absorption component that is capable of absorbing electromagnetic waves of specific frequencies and has low cost and high absorption efficiency.

According to the present invention, the electromagnetic wave absorption component comprises: an electromagnetic shield constituted by at least one material selected from the group consisting of a carbon nanocoil and a carbon fiber; and a solidified layer formed of a mixture of a solidifiable material and the electromagnetic shield after solidification.

The present invention further provides an electromagnetic wave absorption device, which is formed by stacking at least two such electromagnetic wave absorption components, wherein the stacking is by way of depositing on a solidified layer of a first electromagnetic wave absorption component a mixture of a solidifiable material and an electromagnetic shield before solidification and solidifying the material so as to form a second electromagnetic wave absorption component stacked on the first electromagnetic wave absorption component.

According to another embodiment of the present invention, the electromagnetic wave absorption component comprises: an electromagnetic shield constituted by at least one material selected from the group consisting of a carbon nanocoil and a carbon fiber; and a solidified layer formed by solidifying a solidifiable material and for encapsulating the electromagnetic shield.

The electromagnetic wave absorption components and device according to the present invention can not only absorb electromagnetic waves of specific frequencies, but also enhance the electromagnetic wave absorption effect through the stacked structure. The solidified layer can be applied to a variety of daily applications and electronic industries, so as to protect the precise electronic devices in operation against external electromagnetic noises, insulate electromagnetic waves scattered out from the electronic devices and meanwhile selectively absorb or shield the electromagnetic waves harmful to human bodies or other organisms.

### BRIEF DESCRIPTION OF DRAWINGS

FIG. 1 shows the structure and application environment of an electromagnetic wave absorption component of the present invention;

FIG. 2 shows the structure of the electromagnetic wave absorption component according to another embodiment of the present invention;

FIG. 3 shows different electromagnetic wave absorption effects achieved through the electromagnetic wave absorption components having electromagnetic shields of the same thickness but using carbon nanocoils of different molecular lengths;

FIGS. 4A and 4B shows the structures of the electromagnetic wave absorption components according to another embodiment of the present invention;

FIG. 5 shows the structure of an electromagnetic wave absorption device of the present invention;

FIG. 6 shows the electromagnetic wave absorption effect of electromagnetic wave absorption devices according to the present invention; and

FIG. 7 shows the structure of the electromagnetic wave absorption device according to another embodiment of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

FIG. 1 shows the structure and application environment of an electromagnetic wave absorption component of the present invention. As shown in FIG. 1, an electromagnetic wave absorption component 100 is disposed between an electromagnetic wave transmitter 102 and an electromagnetic wave receiver 104 so as to absorb electromagnetic waves emitted from the electromagnetic wave transmitter 102. Further, the electromagnetic wave receiver 104 receives the remaining electromagnetic waves that are not absorbed by the electromagnetic wave absorption component 100.

In the present embodiment, the electromagnetic wave absorption component 100 comprises an electromagnetic shield 101 and a solidified layer 103, wherein the electromagnetic shield 101 is constituted by at least one of the group consisting of a carbon nanocoil (CNC) and a carbon fiber, and the solidified layer 103 is formed of a mixture of a solidifiable material and the electromagnetic shield 101 after solidification.

It should be noted that the composition of the electromagnetic wave absorption component 100 is not limited to the drawing. That is, although the electromagnetic shield 101 is granularly distributed in the solidified layer 103, the electromagnetic shield 101 can be mixed with the solidifiable material in any possible way to be fixed in the solidified layer 103 after the solidifiable material is solidified.

In the present embodiment, if the carbon nanocoil is used as the electromagnetic shield 101, the electromagnetic wave absorption efficiency of the electromagnetic wave absorption component 100 depends on the mass ratio of the carbon nanocoil to the solidifiable material in the solidified layer 103, the thickness of the solidified layer 103 and the average molecular length of the carbon nanocoil. For example, if a plurality of solidified layers 103 has the same thickness and the carbon nanocoils thereof have the same average molecular length, the electromagnetic wave absorption efficiency of the solidified layers 103 depends on the mass ratio of the carbon nanocoil to the solidifiable material. Similarly, if the solidified layers 103 have the same thickness and the same mass ratio of the carbon nanocoil to the solidifiable material, the electromagnetic wave absorption efficiency of the solidified layers 103 depends on the average molecular length of the respective carbon nanocoils of the solidified layers 103. In addition, if the solidified layers 103 have the same mass ratio of the carbon nanocoil to the solidifiable material and the carbon nanocoils thereof have the same average molecular length, the electromagnetic wave absorption efficiency of the solidified layers 103 is proportional to the thickness of the solidified layers 103.

The above-mentioned molecular length of a carbon nanocoil varies according to the growth time of the carbon nanocoil. In general, a carbon nanocoil with longer growth time has longer average molecular length. The electromagnetic wave absorption effect achieved through carbon nanocoils of different molecular lengths will be described later. In the present embodiment, the electromagnetic shield 101 and the solidifiable material are uniformly mixed and solidified to form the solidified layer 103. The solidifiable material is polydimethyl siloxane (PDMS). By using polydimethyl siloxane as the solidifiable material, the electromagnetic shield 101 can be mixed with polydimethyl siloxane as a mixture, and after polydimethyl siloxane is solidified, the electromagnetic shield can be fixed in the solidified polydimethyl siloxane. As a result, the electromagnetic shield 101 can be easily fixed to a substrate requiring electromagnetic wave absorption or noise suppression. The electromagnetic wave absorption component 100 can be attached to the substrate through a tape that is disposed on a surface of the solidified layer 103 of the electromagnetic wave absorption component 100.

On the other hand, if the carbon fiber is used as the electromagnetic shield 101, the electromagnetic wave absorption efficiency of the electromagnetic wave absorption component 100 depends on the mass ratio of the carbon fiber to the solidifiable material in the solidified layer 101 and the thickness of the solidified layer 101.

The application environment of the electromagnetic wave absorption component 100 is not limited to FIG. 1. Instead, the application of the electromagnetic wave absorption component 100 can be varied according to the practical need. For example, the electromagnetic wave transmitter 102 may be a directional antenna, and the electromagnetic waves scattered out from the electromagnetic wave transmitter 101 fall within a specific angular range. Therefore, the electromagnetic wave absorption component 100 can be disposed at a specific angular range between the electromagnetic wave transmitter 102 and the electromagnetic wave receiver 104, thereby efficiently absorbing the electromagnetic waves of specific frequencies emitted from the transmitter 102. Alternatively, the electromagnetic wave transmitter 102 may be non-directional, for example, a line conducting current, an IC device in operation or a mobile phone in use. The electromagnetic wave absorption component can be disposed to cover the outside of an electronic device so as to absorb electromagnetic waves emitted from the electronic device or shield external electromagnetic waves. Alternatively, the electromagnetic wave absorption component can partially cover the electronic device so as to suppress part of noises.

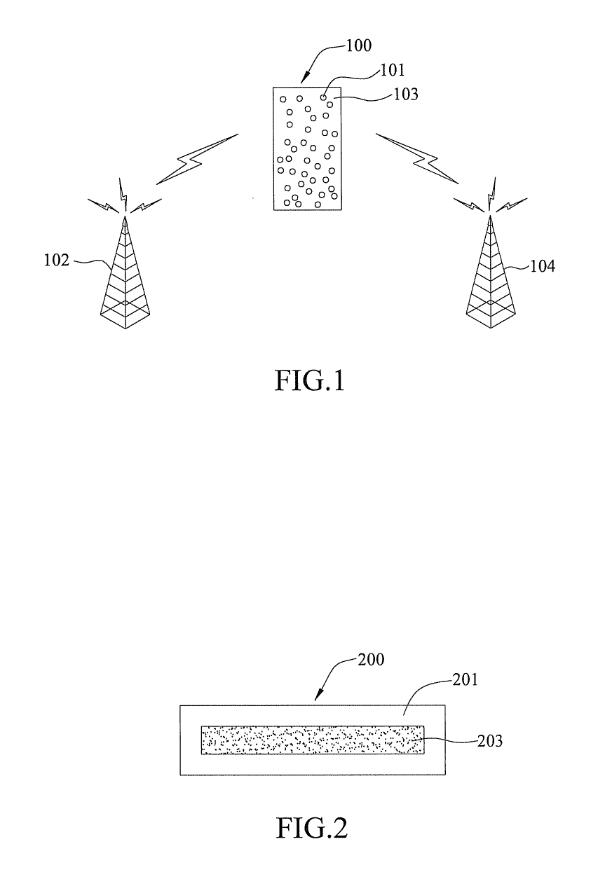

FIG. 2 shows an electromagnetic wave absorption component according to another embodiment of the present invention.

As shown in FIG. 2, the difference of the electromagnetic wave absorption component 200 from the electromagnetic wave absorption component 100 of FIG. 1 is the electromagnetic shield 201 is encapsulated inside the solidified layer 203, thereby forming a sandwich structure.

Same as the electromagnetic shield 101 of FIG. 1, the electromagnetic shield 201 of the present embodiment also comprises at least one material selected from the group consisting of a carbon nanocoil and a carbon fiber, and the solidifiable material is polydimethyl siloxane.

In the present embodiment, if the carbon nanocoil is used as the electromagnetic shield 201, the electromagnetic wave absorption efficiency of the electromagnetic wave absorption component 200 depends on the thickness of the electromagnetic shield 201 formed of the carbon nanocoil and the average molecular length of the carbon nanocoil. For example, the electromagnetic wave absorption efficiency of two electromagnetic shields 201 having the same thickness depends on the average molecular length of the respective carbon nanocoils of the electromagnetic shields 201. Similarly, if the carbon nanocoils of the electromagnetic shields 201 have the same average molecular length, the electromagnetic wave absorption efficiency of the electromagnetic shields 201 is proportional to the respective thickness of the electromagnetic shields 201.

On the other hand, if a material of carbon fiber is used as the electromagnetic shield 201, the electromagnetic wave absorption efficiency of the electromagnetic wave absorption component 200 only depends on the thickness of the electromagnetic shield 201 formed of the carbon fiber.

The application environment of the electromagnetic wave absorption component 200 is not limited to FIG. 2. Instead, the application of the electromagnetic wave absorption component 200 can be varied up to the practical need. For example, the electromagnetic wave absorption component 200 may be disposed as a thin film on an interior of a housing of electronic devices (e.g., mobile phones) so as to absorb electromagnetic waves emitted by the electronic devices or shield external electromagnetic waves. In addition, the electromagnetic wave absorption component 200 can locally or partially cover components or blocks of the electronic devices such as precise apparatus or IC systems, so as to enhance electromagnetic isolation between the blocks of the electronic devices and suppress noises.

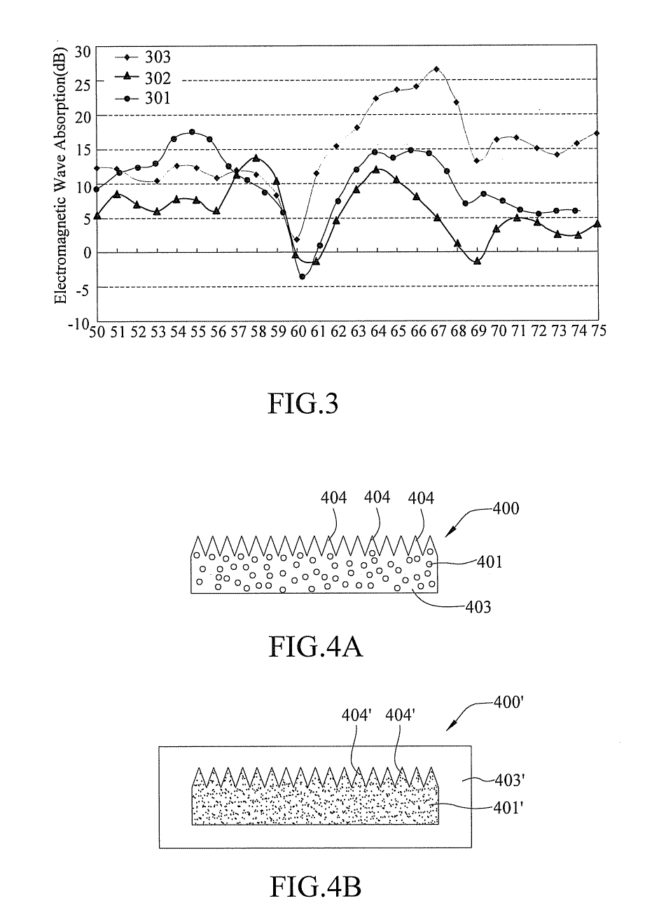

FIG. 3 shows different electromagnetic wave absorption effects achieved by a plurality of electromagnetic shields 201 which have the same thickness but the carbon nanocoils of which have different average molecular lengths. As described before, the electromagnetic wave absorption effect depends on the thickness of the electromagnetic shields 201 and the average molecular length of the respective carbon nanocoils. The molecular length of the carbon nanocoils varies according to the growth time of the carbon nanocoils. In general, a carbon nanocoil with longer growth time has longer average molecular length. Here, the growth time of the carbon nanocoil with an average molecular length of 60 μm is 30 minutes; the growth time of the carbon nanocoil with an average molecular length of 40 μm is 20 minutes; and the growth time of the carbon nanocoil with an average molecular length of 20 μm is 20 minutes. All the electromagnetic shields 201 have the same thickness of 3 mm and are encapsulated in the solidified layer 203. It should be noted that the solidifiable material itself does not affect the electromagnetic wave absorption efficiency of the electromagnetic shields 201 and therefore the thickness of the solidified layer 203 is not specified.

In FIG. 3, curve 301 shows the electromagnetic wave absorption efficiency of an electromagnetic wave absorption component 200 formed of the carbon nanocoil with an average molecular length of 20 μm at different frequencies; curve 302 shows the electromagnetic wave absorption efficiency of an electromagnetic wave absorption component 200 formed of the carbon nanocoil with an average molecular length of 40 μm at different frequencies; and curve 303 shows the electromagnetic wave absorption efficiency of an electromagnetic wave absorption component 200 formed of the carbon nanocoil with an average molecular length of 60 μm at different frequencies.

As shown in FIG. 3, the electromagnetic wave absorption efficiencies of curve 301 and curve 302 are close to each other over a large frequency range except between 50-60 GHz where curves 301 and 302 respectively achieve the optimum electromagnetic wave absorption efficiencies (maximum values). The maximum value of curve 301 is obtained at a frequency of 58 GHz, while the maximum value of curve 302 is obtained at a frequency 54 GHz. Therefore, it can be understood that the average molecular length of the carbon nanocoil can greatly affect the frequency position with the maximum electromagnetic wave absorption value. Further referring to FIG. 3, curve 303 has an excellent electromagnetic wave absorption effect at a frequency range between 64 GHz and 70 GHz, and as high as a value of 26.4 dB is reached at a frequency of 67 GHz.

FIGS. 4A and 4B are structural diagrams of the electromagnetic wave absorption components according to another embodiment of the present invention. As shown in FIG. 4A, the difference of the electromagnetic wave absorption component 400 of the present embodiment from the electromagnetic wave absorption component 100 of FIG. 1 is that one surface of the solidified layer 403 has a plurality of cone-shaped bulges 404.

Next, as shown in FIG. 4B, the difference of the electromagnetic wave absorption component 400′ from the electromagnetic wave absorption component 200 of FIG. 2 is that one surface of the electromagnetic shield 401′ encapsulated in the solidified layer 403′ has a plurality of cone-shaped bulges 404′. The electromagnetic wave absorption efficiency can be improved through the bulges 404 and 404′.

It should be noted that the bulges are not limited to the cone shape. Instead, they can have different shapes according to the practical need. As shown in FIG. 4A, the bulges 404 of the electromagnetic wave absorption component 400 are formed by disposing the solidifiable material that is mixed with the electromagnetic shield 401 in a mold, which is fabricated by etching a silicon wafer and has a shape corresponding to the bulges 404, and then solidifying the solidifiable material, so as for the bulges to be formed on the surface of the solidified layer. As shown in FIG. 4B, to form the bulges 404′ of the electromagnetic wave absorption component 400′, the solidifiable material is disposed in a mold that is formed by etching a silicon wafer and has a shape corresponding to the bulges 404′ and solidified, and then the solidifiable material is released from the mold to cover the electromagnetic shield. But the processes are not limited to thereto. In addition, the parameters of the cone-shaped bulges such as space and depth can be changed according to the required electromagnetic wave absorption efficiency. For example, according to target frequencies of 20 GHz and 60 GHz, the mask for etching the silicon wafer can employ ½ wavelength and ¼ wavelength of the frequency signal. Therein, ¼ wavelength of a 20 GHz signal is 125 μm , and ½ wavelength of a 20 GHz signal is 250 μm; ¼ wavelength of a 60 GHz signal is 375 μm, and ½ wavelength of a 60 GHz signal is 750 μm.

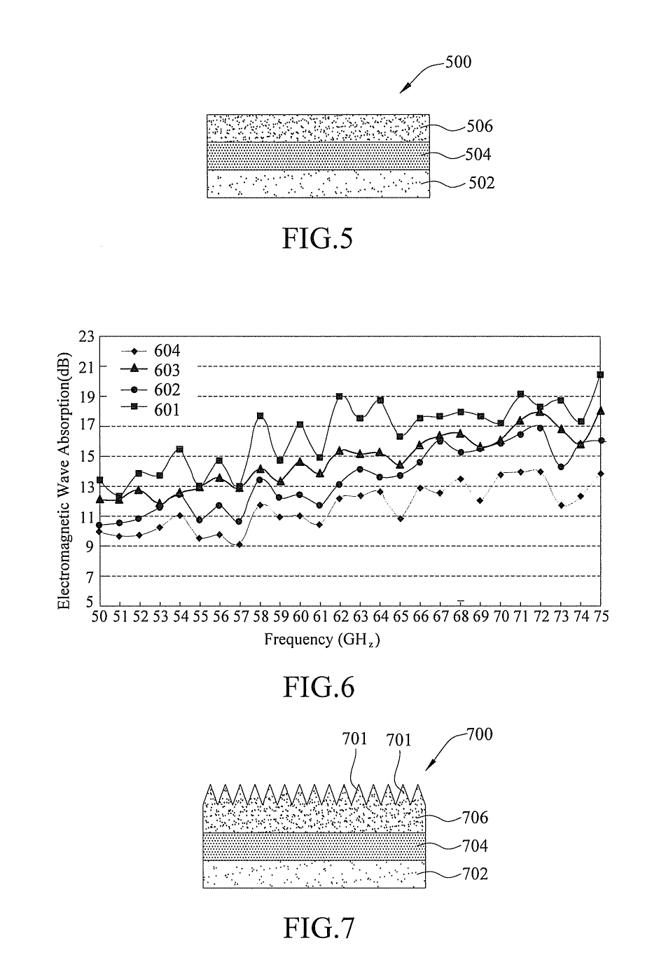

FIG. 5 shows the structure of an electromagnetic wave absorption device of the present invention. The electromagnetic wave absorption device of the present embodiment is formed by stacking a plurality of electromagnetic wave absorption components 502, 504 and 506 on one another. The structure of the electromagnetic wave absorption components is the same as the electromagnetic wave absorption component 100 of FIG. 1.

Therein, the stacking method involves depositing on the solidified layer of a first electromagnetic wave absorption component 502 a solidifiable material mixed with an electromagnetic shield and solidifying it so as to form a second electromagnetic wave absorption component 504 on the first electromagnetic wave absorption component 502. Subsequently, a third electromagnetic wave absorption component 506 is stacked on the second electromagnetic wave absorption component 504 using the same stacking method.

In the present embodiment, the first electromagnetic wave absorption component 502, the second electromagnetic wave absorption component 504 and the third electromagnetic wave absorption component 506 can respectively have different electromagnetic wave absorption efficiencies. For example, the electromagnetic shields of the electromagnetic wave absorption components 502, 504, 506 can have carbon nanocoils of different average molecular lengths such that the electromagnetic wave absorption components 502, 504, 506 obtain the maximum electromagnetic wave absorption values at different frequencies. Further, the electromagnetic wave absorption components 502, 504, 506 can have different mass ratios of the electromagnetic shield to the solidifiable material so as to obtain different maximum electromagnetic wave absorption values even at the same frequency.

FIG. 6 shows the electromagnetic wave absorption effect of electromagnetic wave absorption devices according to the present invention. Curves 601, 602 show the electromagnetic wave absorption efficiency of an electromagnetic wave absorption device constituted by stacking two layers of electromagnetic wave absorption components, wherein the electromagnetic waves of curve 601 are incident from the electromagnetic wave absorption component with a low mass ratio of the electromagnetic shield to the solidifiable material towards the electromagnetic wave absorption component with a high mass ratio of the electromagnetic shield to the solidifiable material, while the electromagnetic waves of curve 602 are incident from the electromagnetic wave absorption component with a high mass ratio of the electromagnetic shield to the solidifiable material towards the electromagnetic wave absorption component with a low mass ratio of the electromagnetic shield to the solidifiable material. Further, curves 603, 604 show the electromagnetic wave absorption efficiency of an electromagnetic wave absorption device formed by stacking three layers of electromagnetic wave absorption components, wherein the electromagnetic waves of curve 603 are incident from the electromagnetic wave absorption component with a high mass ratio of the electromagnetic shield to the solidifiable material towards the electromagnetic wave absorption component with a low mass ratio of the electromagnetic shield to the solidifiable material, while the electromagnetic waves of curve 604 are incident from the electromagnetic wave absorption component with a low mass ratio of the electromagnetic shield to the solidifiable material towards the electromagnetic wave absorption component with a high mass ratio of the electromagnetic shield to the solidifiable material.

Referring to FIG. 6, curves 601, 602 show different electromagnetic wave absorption efficiencies of the electromagnetic wave absorption device based on different incident directions of electromagnetic waves. Therein, the higher electromagnetic wave absorption efficiency is achieved when electromagnetic waves are incident from the electromagnetic wave absorption component with a high mass ratio of the electromagnetic shield to the solidifiable material towards the electromagnetic wave absorption component with a low mass ratio of the electromagnetic shield to the solidifiable material. Further, curves 603, 604 show different electromagnetic wave absorption efficiencies of the electromagnetic wave absorption device formed of three layers of electromagnetic wave absorption components based on different incident directions of electromagnetic waves. Therein, the higher electromagnetic wave absorption efficiency is achieved when electromagnetic waves are incident from the electromagnetic wave absorption component with a low mass ratio of the electromagnetic shield to the solidifiable material towards the electromagnetic wave absorption component with a high mass ratio of the electromagnetic shield to the solidifiable material.

FIG. 7 shows the structure of an electromagnetic wave absorption device according to another embodiment of the present invention. The electromagnetic wave absorption device 700 of the present embodiment comprises three electromagnetic wave absorption components 702, 704 and 706 that are stacked on one another. As shown in the drawing, a plurality of cone-shaped bulges 701 is formed on a surface of the solidified layer of the electromagnetic wave absorption component 706 that is in direct contact with the atmosphere of the surrounding. The shape of the bulges 701 is not limited to the cone shape.

According to the present invention, at least one of a carbon nanocoil and a carbon fiber is encapsulated in a solidified layer, or a solidifiable material is mixed with at least one of a carbon nanocoil and a carbon fiber and solidified so as to reduce the cost and improve the electromagnetic wave absorption efficiency. Further, due to solidification of the solidifiable material, the electromagnetic wave absorption components and devices formed therefrom are applicable to various applications requiring insulation or absorption of electromagnetic waves.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An electromagnetic wave absorption component, comprising:
an electromagnetic shield constituted by at least one material selected from the group consisting of a carbon nanocoil and a carbon fiber; and
a solidified layer formed of a mixture of a solidifiable material and the electromagnetic shield after solidification.

2. The component of claim 1, wherein molecular length the carbon nanocoil has a molecular length varying with a growth time of the carbon nanocoil.

3. The component of claim 1, wherein the electromagnetic shield is uniformly distributed in the solidifiable material.

4. The component of claim 1, wherein the solidifiable material is polydimethyl siloxane (PDMS).

5. The component of claim 1, wherein one surface of the solidified layer has a plurality of bulges.

6. The component of claim 5, wherein the bulges are of a cone shape.

7. The component of claim 5, wherein the bulges are formed by disposing in a mold fabricated by etching a silicon wafer the mixture of the solidifiable material and the electromagnetic shield before solidification, so as for the bulges to be formed on the surface of the solidified layer.

8. An electromagnetic wave absorption device formed by stacking at least two electromagnetic wave absorption components of claim 1.

9. The device of claim 8, wherein the stacking is by way of depositing on a solidified layer of a first electromagnetic wave absorption component a mixture of a solidifiable material and an electromagnetic shield before solidification and solidifying the mixture so as to form a second electromagnetic wave absorption component stacked on the first electromagnetic wave absorption component.

10. The device of claim 8, wherein the solidified layer of each of the at least two electromagnetic wave absorption components is formed by solidifying a mixture of a solidifiable material and a carbon nanocoil with a different molecular length.

11. The device of claim 8, wherein the at least two electromagnetic wave absorption components have different mass ratios of the electromagnetic shield to the solidifiable material.

12. The device of claim 8, wherein the electromagnetic shield is uniformly distributed in the solidifiable material.

13. The device of claim 8, wherein the solidifiable material is polydimethyl siloxane (PDMS).

14. The device of claim 8, wherein a surface of the solidified layer in one of the at least two electromagnetic wave absorption components is in direct contact with the atmosphere and has a plurality of bulges.

15. The device of claim 14, wherein the bulges are of a cone shape.

16. The device of claim 14, wherein the bulges are formed by disposing in a mold fabricated by etching a silicon wafer the mixture of the solidifiable material and the electromagnetic shield before solidification, so as for the bulges to be formed on the surface of the solidified layer.

17. An electromagnetic wave absorption component, comprising:
an electromagnetic shield constituted by at least one material selected from the group consisting of a carbon nanocoil and a carbon fiber; and
a solidified layer formed by solidifying a solidifiable material for encapsulating the electromagnetic shield.

18. The component of claim 17, wherein a molecular length of the carbon nanocoil has a molecular length varying with a growth time of the carbon nanocoil.

19. The component of claim 17, wherein one surface of the solidified layer has a plurality of cone-shaped bulges.

20. The component of claim 19, wherein the solidifiable material is polydimethyl siloxane (PDMS).
